(19) United States
(12) Patent Application Publication
(10) Pub. No.: US 2005/0238152 A1
(43) Pub. Date: Oct. 27, 2005

(54) Prepaid long distance calling card automatic reader dialer

(76) Inventor: Rodrick Darel Tidwell, Little Rock, AR (US)

Correspondence Address: Rodrick Tidwell;Ste 3, 7212 Geyer Springs Rd., Little Rock, AR, 72209, US

(21) Appl. No.: 10/831,914

(22) Filed: Apr. 26, 2004

(51) Int. Cl. H04M 15/00

(52) U.S. Cl. 379/114.2; 379/114.24

(57) ABSTRACT

A process and device for connecting prepaid long distance 800 numbers and pin numbers to service providers' networks. The device has a magnetic reader, a microprocessor controller, and a DTMF generator. The magnetic reader reads the 800 number and the pin number from the encoded magnetic strip attached to the prepaid long distance calling card. The microprocessor is electrically coupled to the magnetic reader and programmed to receive and store the 800 number and the pin number. The microprocessor is electrically coupled to the DTMF generator and is programmed to transmit the 800 number to the DTMF generator. The DTMF generator dials the 800 number and connects to the prepaid long distance carrier's network. Once the carrier's network has been accessed, there is a voice prompt. The microprocessor is electrically coupled to three buttons and is programmed to transmit the designated tones: one for English, two for Spanish, or the pin number.

### FIELD OF THE INVENTION

The present invention relates generally to the field of telecommunication and more specifically to device and process for dialing 800 and pin numbers of a prepaid long distance calling card; a process in which the device stores and dials 800 and pin numbers of a prepaid calling card.

### BACKGROUND OF THE INVENTION

Convenience and efficiency are atop the list as most desirable attributes for subscribers of telecommunication services. Moreover, it is the desire of capitalist to create as much subscriber convenience as possible. Prepaid Long Distance Calling Cards can now be found in almost every C-Store as well as in your large retailers like Wal-Mart, K-Mart, and Target. They're used in toll restricted college dorms all over the country. They're used when traveling. Prepaid Long Distance Calling Cards continue to have strong presence in everyday life. The widespread use of local prepaid calling plans where long distance is restricted or where long distance is preferred restricted and the use of long distance prepaid calling cards are common, shows a principle gap in present technology between commercial payphones and conventional residential service. The use of card reading mechanisms for commercial operated payphones normally located in airports, train stations, and heavy traffic street places is quite common; however, in conventional telecommunications, a given user associated with a prepaid long distance calling card has no option other than the manual dialing of the 800 number and the pin number whether the user is at home or at a payphone. Oftentimes the numbers on a prepaid long distance calling card are small and unreadable which makes the process of dialing them quite cumbersome and the chance for error high.

Prepaid long distance calling cards storing a prescribed prepaid amount of a telephone fee have become widespread. By inserting such a telephone card in a specially adapted telephone capable of using the card, a telephone call can be placed. There have been other attempts of incorporating some type of card-reader apparatus with telephone equipment. The prior attempts involved the verification of credit card information and were designed to be integrated with commercial public payphones installed with credit card reading mechanisms. Other attempts involve card reading mechanisms used for the purposes of retail and ATM that require the interface of special software and computers. None of the prior art has attempted to encode the magnetic strip of an over-the-counter long distance prepaid calling card with the respective 800 and pin numbers nor have there been any attempts to create a device to read and dial 800 and pin numbers of an over-the-counter long distance prepaid calling card. Such form of telephone credit card and bar code systems that were integrated with general computers, public payphones and other systems are described in U.S. Pat. Nos. 4,595,983; 4,326,123; 4,868,849; 4,817,136 and 5,144,654. The prior art in these patents are very similar in that they require virtually the same functioning components to achieve reading, storing, or dialing information; however, the objectives of each demonstrate a purpose for credit cards and/or a relationship to public payphones, general computer integration or special adapted telephones.

Prior art makes no attempts to address card readers and auto-dialers with regards to over-the-counter prepaid long distance calling cards and conventional residential telephones with respect to one another. Furthermore, no consideration is apparent in the prior art for conventional residential use as it relates to those who are visually impaired or blind.

### OBJECTS OF THE INVENTION

It is, therefore, one of the primary objects of the present invention to eliminate the manually dialing of 800 and pin numbers of conventional over-the-counter long distance prepaid calling cards.

It is another objective of the present invention to provide a standard format for long distance prepaid calling card manufacturers to encode conventional over-the-counter long distance prepaid calling cards' magnetic strips with the respective 800 and pin numbers.

It is another objective of the present invention to provide a device that reads and stores the 800 and pin numbers of a magnetic strip of a long distance prepaid calling card.

It is another objective of the present invention to provide a device that automatically dials the 800 number and pin number of a long distance prepaid calling card.

It is another objective of the present invention to provide the visually challenged and blind consumer an efficient and effective means to use long distance prepaid calling cards by eliminating the need to manually dial 800 and pin numbers.

It is another objective of the present invention to provide a lightweight external component that is easily connected by RJ11 cable to a conventional land line phone and the wall jack.

It is another objective of the present invention to provide a device that easily interfaces with conventional residential phones.

Other objects and advantages of the present invention will become apparent from the following descriptions, taken in connection with the accompanying drawings, wherein, by way of illustration and example, an embodiment of the present invention is disclosed.

### SUMMARY

The embodiment of the present invention provides a conventional over-the-counter prepaid long distance calling card that comprises a magnetic strip digitally encoded with the respective 800 number and pin number. The 800 number and pin number are digitally encoded in such manner that it is capable of being read, stored, and dialed.

The present invention also provides an apparatus for reading and dialing the encoded 800 number and pin number of the prepaid long distance calling card. The apparatus is a small box that is easily connected to a conventional home phone and wall jack by RJ11 cables. Thus, when a prepaid long distance card is inserted into the apparatus, it is read by the magnetic reader that reads the magnetic strip of the card. The 800 number and the pin number of the magnetic strip is then stored in the micro-controller and relayed to the DTMF generator that automatically dials the 800 number. After connection with the service provider, prompts for English, Spanish, or the Pin number are asked for and corresponding touchtone buttons can be pressed. Thus, a desired call may be placed and the probability of error is greatly reduced.

In accordance with the objectives of the present invention, a user of a prepaid long distance calling card can utilize the apparatus to eliminate the cumbersome dialing of 800 numbers and pin numbers to make long distance calls. In addition, users who are blind or visually impaired will have an effective and efficient means to complete long distance calls.

### DESCRIPTION OF THE DRAWINGS

FIG. 1 is a view schematically illustrating a telephone card embodying the present invention;

FIG. 2 is a block diagram illustrating a telephone device in which the telephone card of the invention is used;

FIG. 3 is a flow chart that explains the reading of a digitally encoded telephone number on a member which may be used in accordance with the present invention and which may form part of the apparatus of FIG. 8;

FIG. 4 is a top plan view thereof;

FIG. 5 is a side elevational view thereof;

FIGS. 6 and 7 are respectively front and back elevational views thereof; and

FIG. 8 is a right side, top and front perspective view of one form of a prepaid long distance calling card reader and dialing device constructed in accordance with and embodying the present invention.

### DETAILED DESCRIPTION OF THE PREFERRED EMBODIMENTS

Referring now in more detail and by reference characters to the drawings that illustrate a preferred embodiment of the present invention.

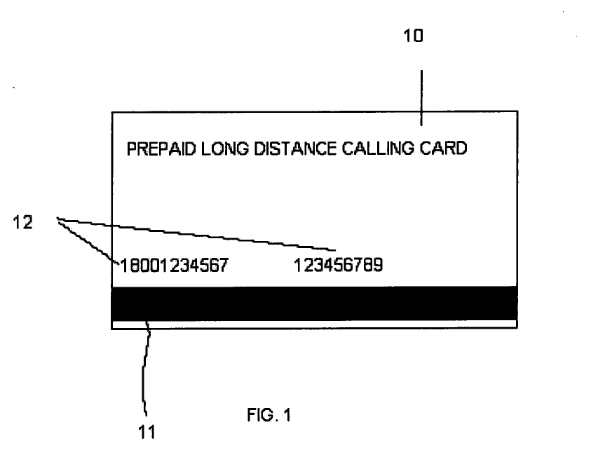

FIG. 1 is a view schematically illustrating a conventional over-the-counter prepaid long distance calling card 10 that is constructed in accordance with and embodies the present invention. This prepaid long distance calling card 10 comprises a magnetic strip 11 encoded with an 800 number 12 and a pin number 12.

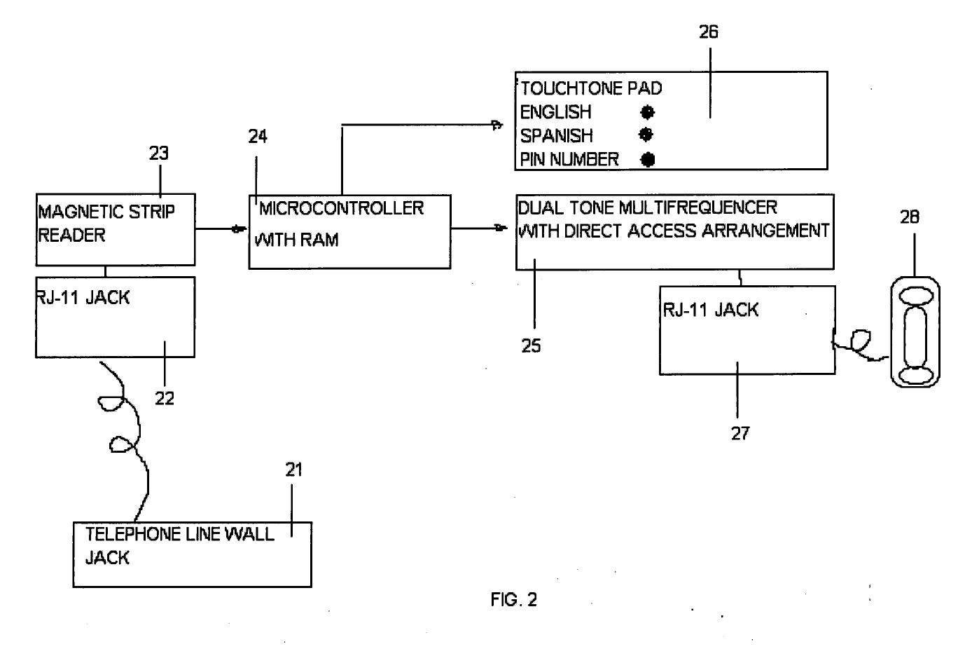

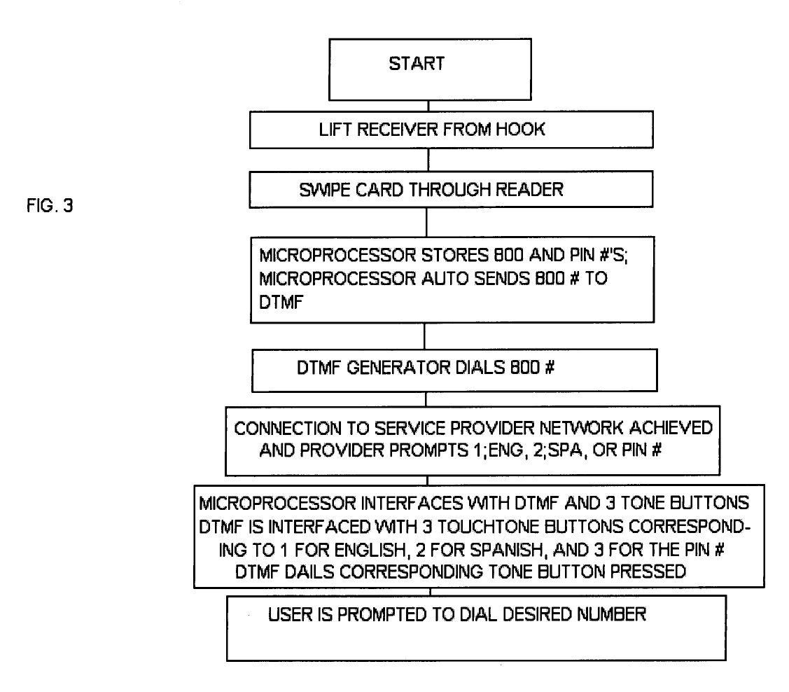

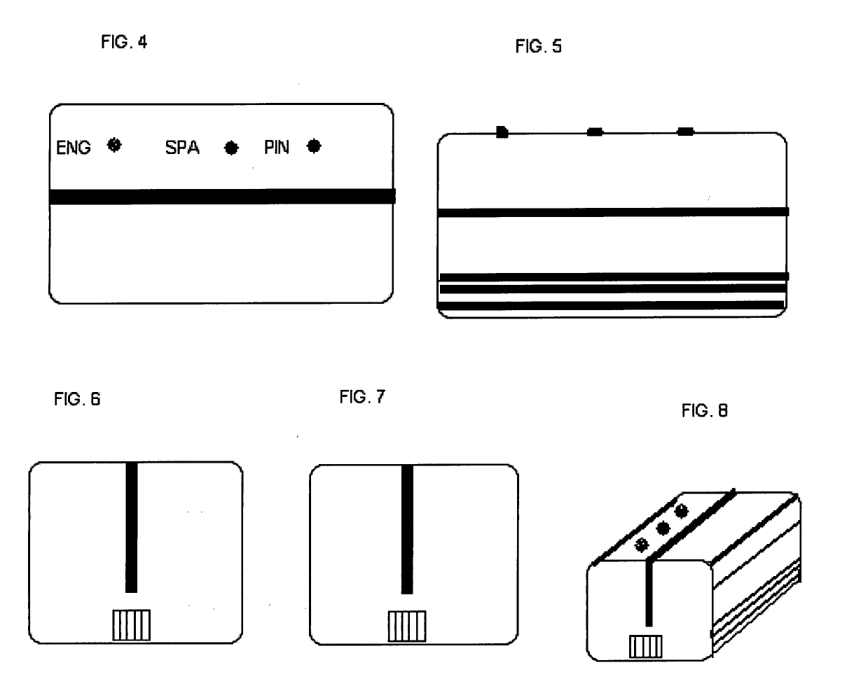

FIG. 2 shows a block diagram of a magnetic strip reader-dialer using readily available components to include RJ11 Jacks 22, a Magnetic Strip Reader 23, a Micro-controller 24 with random access memory, a Touchtone Pad 26, and a DTMF generator 25. This auto dialer reads the Magnetic strip 11 of the prepaid long distance calling card 10 shown in FIG. 1. The magnetic strip 11 represents the 800 number 12 and the pin number 12 of the prepaid long distance calling card 10.

The RJ11 Jacks 22 and 27 provide the connection of the reader-dialer to the Phone line 21 and a conventional Telephone 28. The Magnetic Strip Reader 23 is swiped with the Prepaid Long Distance Calling Card 10 and is read by the Magnetic Strip Reader 23. The Micro-controller 24 is coupled with the Magnetic Strip Reader 23 and receives input signals representing the 800 number 12 and the Pin number 12 read by the Magnetic Strip Reader 23. The Micro-controller 24 stores the 800 number 12 and the Pin number 12 along with pre-programmed and stored numbers corresponding to the service provided prompts for English, Spanish and the Pin number 12. The Micro-controller 24 sends input signals for the 800 number 12 to the DTMF generator 25. The DTMF generator 25 has direct access arrangement (DAA) that allows the DTMF generator 25 isolated phone line interface. The DTMF generator 25 dials the 800 number 12 and connects to the service provider's network.

There is a three button Touchtone Pad 26 connected to the Micro-controller 24 and the DTMF generator 25. When service provider access is gained, there are prompts for a user to specify English, Spanish, or the Pin number 12. The three button touchtone pad 26 corresponds to English, Spanish and the Pin number 12 allowing a user to press the prompted action. Once the corresponding button is pressed, the Micro-controller 24 sends the designated signal to the DTMF generator 25 that generates the corresponding tone signal and connects to the service provider's network. The desired call can be completed.

1. A process of placing a prepaid long distance call free of manually entering an 800 number and a pin number, said method comprising:
encoding the magnetic strip of a prepaid long distance calling card with an 800 number and a pin number;
magnetically reading said magnetic strip of said prepaid long distance calling card to retrieve and process said 800 number and said pin number;
storing said 800 number and said pin number;
electrically transmitting said 800 number and said pin number to the service carrier network; and
enabling the user to process said prepaid long distance call.

2. A communications apparatus for reading the 800 number and the pin number of an encoded magnetic strip of a long distance prepaid calling card and capable of transmitting communications of said 800 number and said pin number to a service carrier's external network, said communications apparatus comprising:
a magnetic strip reader with TTL output that is swiped with an encoded long distance prepaid calling card;
said magnetic strip reader is connected to a microprocessor that receives, stores, and processes the data retrieved from said magnetic strip reader;
said microprocessor is connected to a DTMF generator and sends processed information to said DTMF generator;
said DTMF generator with direct access arrangement (DAA) dials said 800 number to connect to a service carrier's external network;
a three (3) button keypad connected to said DTMF generator allows the dialing of tones when prompted English, Spanish, and/or said pin number; and
the apparatus is embodied in a plastic casing with a female RJ11 connector on both ends to allow connection to CPE landline telephones and a wall jack.

3. A process of claim 1, wherein said long distance prepaid calling card is encoded with said 800 number and said pin number.

4. A process of claim 1, wherein a standardized format for encoding said 800 number and said pin number for the long distance prepaid calling card manufacturers is accomplished.

5. A process of claim 1, wherein the need to manually dial said 800 number and said pin number is eliminated.

6. A process of claim 1, wherein the use of prepaid long distance calling cards is efficient and convenient for consumers who are visually challenged and blind.
